(19) United States
(12) Patent Application Publication
(10) Pub. No.: US 2009/0169266 A1
(43) Pub. Date: Jul. 2, 2009

(54) POWDER TRANSPORTING APPARATUS AND IMAGE FORMING APPARATUS INCLUDING THE SAME

(76) Inventor: Shinichi UEHARA, Atsugi-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/343,993

(22) Filed: Dec. 24, 2008

(30) Foreign Application Priority Data
Dec. 28, 2007 (JP) 2007-341159

(51) Int. Cl. G03G 15/08

(52) U.S. Cl. 399/258

(57) ABSTRACT

A powder transporting apparatus is made up of: a powder container containing therein powder; a transportation tank having an inlet for supplying the powder from the powder container, and an outlet for discharging the powder to an outside; a conveying device disposed in the transportation tank and rotated about an axis to thereby transport the powder in the transportation tank from the inlet to the outlet; and a suction device disposed outside the transportation tank. The suction device sucks gas in the transportation tank through a suction port which is away from both the inlet and the outlet of the transportation tank. The powder in the powder container is thus sucked into the transportation tank.

### CROSS REFERENCE TO RELATED APPLICATIONS

The present application is based on and claims priority from Japanese Application Number 2007-341159, filed on Dec. 28, 2007, the disclosure of which is hereby incorporated by reference herein in its entirety.

### BACKGROUND OF THE INVENTION

1. Field of the Invention

The present invention relates to an apparatus for transporting (or conveying) powder such as toner to a developing apparatus in an image forming apparatus such as a copying machine, a fax machine, a printer, and the like. The invention also relates to an image forming apparatus including the apparatus for transporting powder. The apparatus for transporting powder is also referred to in the invention as a powder transporting apparatus.

1. Description of the Related Art

An image forming apparatus such as a printer is conventionally provided with a powder transporting apparatus 100 which transports powder in the form of toner from a powder container in the form of a toner container to a development device (see FIG. 17 and JP-A-2000-351445, now Japanese Patent No. 4132412).

The powder transporting apparatus 100 as exemplified in FIG. 17 is provided with: a stator 101 which is made of an elastic material such as rubber and is formed into a cylinder with a screw groove formed on an inner circumference of the cylinder; and a rotor 102 which is housed in the stator 101 and is formed into a screw in a manner to be rotatable about an axis of the rotor 102. Between the stator 101 and the rotor 102, there is provided a space only between the groove and a rotor vane; otherwise there is no space provided therebetween.

The powder transporting apparatus 100 is so arranged that, as a result of rotation of the rotor 102 within the stator 101 about the axis of the rotor 102, the powder in the toner container is sucked into the stator 101 from one end thereof to thereby transport the powder through the stator 101 to the other end thereof for discharging the powder from the other end to an image forming apparatus.

However, the powder transporting apparatus 100 as disclosed in JP-A-2000-351445 (now Japanese Patent No. 4132412) transports the powder such as toner accompanied by the rotation of the rotor 102 about the axis while the stator 101 and the rotor 102 rubbing each other. As a result, a frictional heat is generated between the stator 101 and the rotor 102 and the frictional heat is stored in the stator 101 and the rotor 102. The heat thus stored in the stator 101 and the rotor 102 is transmitted to the toner which is in contact with the stator 101 and the rotor 102.

Further, as noted above, there is provided only a space between the stator 101 and the rotor 102 and the space in question is small. Consequently, the powder such as toner is pounded or is subjected to grinding by the stator 101 and the rotor 102. In this manner, the conventional powder transporting apparatus 100 gives thermal stress to the powder such as toner. In case the toner contains a thermoplastic resin, the resin gets molten due to the above-described heat, resulting in agglomeration or sticking of the powder such as toner.

Still furthermore, the above-described powder transporting apparatus 100 is provided only with the narrow space between the stator 101 and the rotor 102, and the stator 101 and the rotor 102 get rubbed with each other. Therefore, due to the heavy driving torque of the rotor 102 and the frictional heat generation, there is a problem in that the energy of the driving source to rotate the rotor 102 cannot be efficiently utilized.

Furthermore, there is another problem in that, since the friction between the stator 101 and the rotor 102 is large, the stator 101 and the rotor 102 get ground or the powder such as toner gets adhered, resulting in the occurrence of decrease in the suction capacity at a relatively early stage. In view of the above-described problems, the invention has an object of providing a powder transporting apparatus that is capable of transporting the powder while minimizing the thermal stress to be given to the powder which is an object to be transported. The invention also has an object of providing an image forming apparatus including the powder transporting apparatus.

### SUMMARY OF THE INVENTION

According to an aspect of the invention, a powder transporting apparatus comprises: a powder container containing therein powder; a transportation tank having an inlet for supplying the powder from the powder container, and an outlet for discharging the powder to an outside; a conveying device disposed in the transportation tank and rotated about an axis to thereby transport the powder in the transportation tank from the inlet to the outlet; and a suction device disposed outside the transportation tank. The suction device sucks gas in the transportation tank through a suction port which is away from both the inlet and the outlet of the transportation tank. The powder in the powder container is thus sucked into the transportation tank.

According to the above arrangement, the powder is sucked from the powder container into the transportation tank by sucking the gas in the transportation tank. In other words, a negative pressure is generated in the transportation tank in order to suck the powder into the transportation tank. In addition, the suction device for generating a negative pressure in the transportation tank is disposed outside the transportation tank. Therefore, the heat to be generated by the suction device can be prevented from being transmitted to the powder. Further, since the powder is sucked into the transportation tank by negative pressure, the powder can be sucked into the transportation tank without being subjected to grinding operation. In this manner, while minimizing the thermal stress to be given to the powder, the powder can still be transported.

### BRIEF DESCRIPTION OF THE DRAWINGS

FIG. 1 is a sectional view of an image forming apparatus relating to one embodiment of the invention;

FIG. 2 is a sectional view of a process cartridge of the image forming apparatus of FIG. 1;

FIG. 3 is a diagrammatic sectional view illustrating the arrangement of a developer feed apparatus of the image forming apparatus of FIG. 1;

FIG. 4 is a diagrammatic sectional view illustrating a state in which the developer feed apparatus of FIG. 3 has sucked toner;

FIG. 5 is a diagrammatic sectional view illustrating a state in which the developer feed apparatus of FIG. 4 has equalized the pressure in the transportation tank with the pressure outside the transportation tank;

FIG. 6 is a diagrammatic sectional view illustrating a state in which the developer feed apparatus of FIG. 5 has discharged the toner out of the transportation tank;

FIG. 7 is a schematic view illustrating an enlarged open/close device of the developer feed apparatus of FIG. 3;

FIG. 8 is a schematic view showing an enlarged open/close device of the developer feed apparatus of FIG. 4;

FIG. 9 is a graph showing the change in pressure in the transportation tank of the developer feed apparatus of FIG. 3;

FIG. 10 is a diagrammatic sectional view illustrating a state in which the developer feed apparatus of FIG. 3 has supplied the toner container with gas;

FIG. 11 is a schematic view illustrating the construction of a modified example of the developer feed apparatus of FIG. 3;

FIG. 12 is a schematic view illustrating the construction of a modified example of the suction pump of the developer feed apparatus of FIG. 3;

FIG. 13 is a schematic view illustrating the construction of a further modified example of the suction pump of the developer feed apparatus of FIG. 3;

FIG. 14 is a diagrammatic sectional view illustrating the construction of a modified example of the developer feed apparatus of FIG. 3;

FIG. 15 is a diagrammatic sectional view illustrating the construction of a modified example of the developer feed apparatus of FIG. 3;

FIG. 16 is a schematic view illustrating the construction of a modified example of the toner container of the developer feed apparatus of FIG. 3; and

FIG. 17 is a diagrammatic sectional view illustrating the construction of a conventional powder transporting apparatus.

### DETAILED DESCRIPTION OF THE PREFERRED EMBODIMENTS

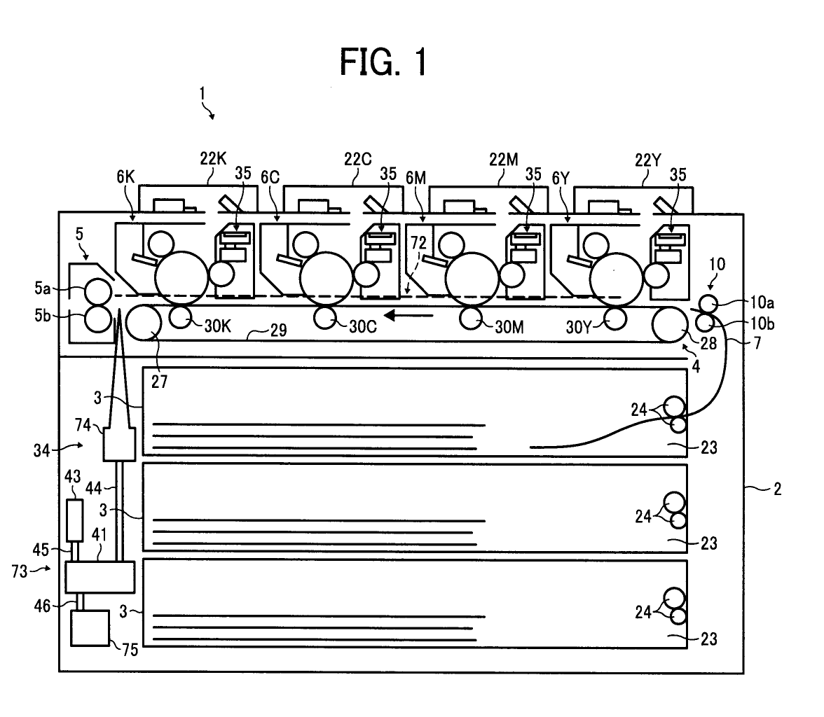

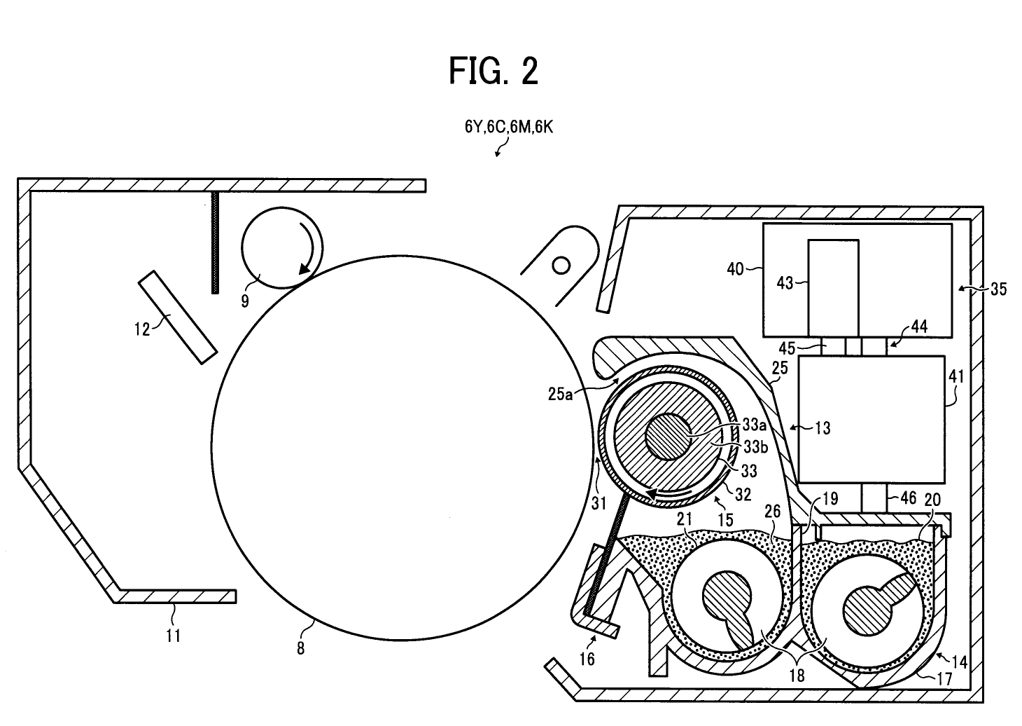

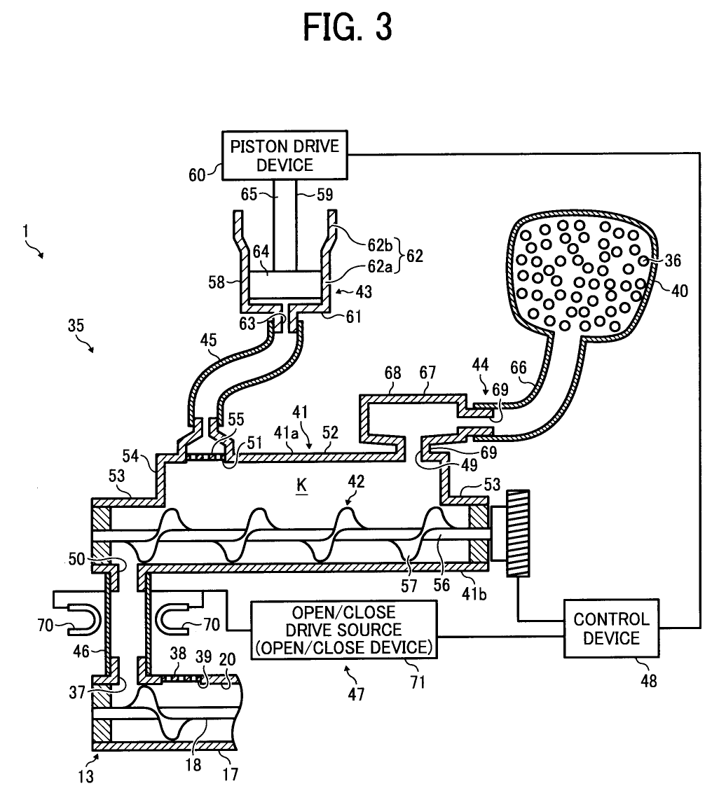

With reference to the accompanying FIGS. 1 through 10, a description will be made about an embodiment of the invention. FIG. 1 shows a sectional view of an image forming apparatus according to an embodiment of the invention. FIG. 2 is a sectional view of a process cartridge of the image forming apparatus shown in FIG. 1. FIG. 3 is a diagrammatic sectional view illustrating the arrangement of a developer feed apparatus of the image forming apparatus in the form of a developer feed apparatus 35.

The image forming apparatus 1 forms an image of various colors of yellow (Y), magenta (M), cyan (C) and black (K), i e., a color image, on a piece of recording paper 7 (see FIG. 1) as a transfer material. The unit and the like corresponding to each of the colors of yellow, magenta, cyan and black is shown by affixing reference alphabets Y, M, C and K to each of the reference numerals.

The image forming apparatus 1 comprises, as shown in FIG. 1, an apparatus main body 2, a paper feed unit 3, a pair of resist rollers 10, a transfer unit 4, a fixing unit 5, a plurality of laser inscription units 22Y, 22M, 22C and 22K, a plurality of process cartridges 6Y, 6M, 6C and 6K, and a developer recovery unit (developer sump) 34.

The apparatus main body 2 is formed, e.g., into a box and is disposed on a floor and houses therein the paper feed unit 3, the pair of resist rollers 10, the transfer unit 4, the fixing unit 5, the plurality of laser inscription units 22Y, 22M, 22C and 22K, and a plurality of process cartridges 6Y, 6M, 6C and 6K.

The paper feed unit 3 is provided in a plurality of pieces at a lower portion of the apparatus main body 2 and is provided with a paper feed cassette 23 which stores therein the above described pieces of recording paper 7 in a stacked manner and which can be pushed into and pulled out of the apparatus main body 2, and paper feed rollers 24. The paper feed rollers 24 are urged against the uppermost pieces of paper 7 respectively in the paper feed cassettes 23. The paper feed rollers 24 feed the uppermost piece of paper 7 to a position between a transporting belt 29 (to be described hereinafter) and a photosensitive drum 8 of the development device 13 (to be described hereinafter) of the process cartridges 6Y, 6M, 6C and 6K.

The pair of resist rollers 10 are disposed in a transporting passage of the recording paper 7 which is transported from the paper feed unit 3 to the transfer unit 4, and are provided with a pair of rollers 10a and 10b. The pair of resist rollers 10 pinch or hold the recording paper 7 between the rollers 10a and 10b, and feed it out to a space between the transfer unit 4 and the process cartridges 6Y, 6M, 6C and 6K at a timing in which the pinched piece of paper 7 can be overlapped with a toner image.

The transfer unit 4 is disposed above the paper feed unit 3 and is provided with a driving roller 27, a driven roller 28, a transfer belt 29, and transfer rollers 30Y, 30M, 30C and 30K. The driving roller 27 is disposed on a downstream side of the direction of transporting the recording paper 7 and is driven for rotation by a motor and the like which serves as a driving source. The driven roller 28 is rotatably supported by the apparatus main body 2 and is disposed on an upstream side of the direction of transporting the recording paper 7. The transfer belt 29 extends in an endless manner between the driving roller 27 and the driven roller 28. The transfer belt 29 circulates (travels endlessly) counterclockwise as seen in the figure between the driving roller 27 and the driven roller 28 as a result of driving for rotation of the driving roller 27.

The transfer rollers 30Y, 30M, 30C and 30K pinch or hold the transfer belt 29 and the recording paper 7 lying on the transfer belt 29 against the photosensitive drum 8 of the respective process cartridges 6Y, 6M, 6C and 6K. In the transfer unit 4 the transfer rollers 30Y, 30M, 30C and 30K urge the recording paper 7 paid out of the paper feed unit 3 against the outer surface of the photosensitive drum 8 to thereby transfer the toner image on the photosensitive drum 8 to the recording paper 7. The transfer unit 4 then discharges the recording paper 7 having transferred thereto the toner image to the fixing unit 5.

The fixing unit 5 is disposed on a downstream side of the transfer unit 4, as seen in the direction of traveling of the recording paper 7, and is provided with a pair of rollers 5a and 5b which pinch the recording paper 7 therebetween. The fixing unit 5 operates to heat under pressure, between the pair of rollers 5a and 5b, the recording paper 7 that has been fed from the transfer unit 4. The toner image that has been transferred from the photosensitive drum 8 to the recording paper 7 is thus fixed to the recording paper 7.

The laser inscription units 22Y, 22M, 22C and 22K are respectively disposed on an upper part of the apparatus main body 2, and are arranged to correspond to the respective process cartridges 6Y, 6M, 6C and 6K. The laser inscription units 22Y, 22M, 22C and 22K form an electrostatic latent image by irradiating laser beam to the outer surface of the photosensitive drum 8 that has bee uniformly charged by a charging roller 9 (to be described in detail hereinafter) of the process cartridges 6Y, 6M, 6C and 6K.

The process cartridges 6Y, 6M, 6C and 6K are respectively disposed between the transfer unit 4 and the laser inscription units 22Y, 22M, 22C and 22K, and are detachable relative to the apparatus main body 2. The process cartridges 6Y, 6M, 6C and 6K are disposed in parallel with each other along the direction of traveling of the recording paper 7.

Each of the process cartridges 6Y, 6M, 6C and 6K is provided, as shown in FIG. 2, with a cartridge case 11, the charging roller 9 as a charging device, the photosensitive drum 8 as an image carrier, a cleaning blade 12 as a cleaning device, the development device 13, and the developer feed apparatus 35 as a powder transporting apparatus. Therefore, the image forming apparatus 1 comprises at least the charging roller 9, the photosensitive drum 8, the cleaning blade 12, the development device 13, and the developer feed apparatus 35 as the powder transporting apparatus.

The cartridge case 11 is detachable to the apparatus main body 2 and houses therein the charging roller 9, the photosensitive drum 8, the development device 13, and the developer feed apparatus 35. The charging roller 9 is arranged to electrostatically charge the outer surface of the photosensitive drum 8 uniformly.

The photosensitive drum 8 is disposed at a distance to a developing roller 15 (to be described in detail hereinafter) of the development device 13, and is formed into a cylindrical or columnar shape which is rotatable about an axis. On an outer surface of the photosensitive drum 8 there will be formed an electrostatic latent image by means of the corresponding laser inscription units 22Y, 22M, 22C and 22K. Toner 36 (see FIG. 3) gets adsorbed on the electrostatic latent image formed and carried on the outer surface of the photosensitive drum 8. The toner image thus obtained is developed and is transferred to the recording paper 7 which is positioned in a space between the photosensitive drum 8 and the transporting belt 29. The cleaning blade 12 functions to remove the toner 36 staying on the outer surface of the photosensitive drum 8 after having transferred the toner image to the recording paper 7.

The development device 13 comprises, as shown in FIG. 2, at least the developer feed part 14, the casing 25, a metering blade 16 as a restricting member, and a developing roller 15 as a developer carrier.

The developer feed part 14 is provided with a container tank 17 and a pair of agitating screws 18 as an agitating member. The container tank 17 is formed into a box shape which is approximately equal in length to the photosensitive drum 8. The container tank 17 is provided therein with a partition wall 19 which is elongated in the longitudinal direction of the container tank 17. The partition well 19 partitions the container tank 17 into a first space 20 and a second space 21 which are in communication with each other at both ends.

The container tank 17 contains the developer 26 in both the first space 20 and the second space 21. The developer 26 contains therein the toner 36 (see FIG. 3) as the powder and magnetic carrier. Out of the first space 20 and the second space 21, the first space 20 which lies away from the developing roller 15 has on its one end an opening in the form of a feed port 37 as shown in FIG. 3. The toner 36 is fed or supplied when necessary through the feed port 37 by means of a developer feed apparatus 35 which is described in detail hereinafter. Further, there is provided at one end of the first space 20 a discharge port 39 closed by a filter 38 which allows the gas (air) to pass therethrough but prevents the toner 36 from passing threrethrough.

The toner 36 is a spherical particulate matter which is manufactured by an emulsion polymerization method or a suspension polymerization method. The toner 36 may otherwise be obtained by grinding particulates made of a resin into which various dyes or pigments are mixed and dispersed. The toner 36 has an average particle size of above 3 μm and below 7 μm. Otherwise, the toner 36 may be formed by other grinding methods and the like.

The magnetic carrier is contained in both the first space 20 and the second space 21. An average particle size of the magnetic carrier is above 20 μm and below 35 μm. The magnetic carrier is made up of: a spherical core material constituted by a ferrite as the magnetic material; a resin coating film containing a resin ingredient in which the thermoplastic resin and melamine resin such as acryl are cross-linked, and charge-adjusting agent, the outer surface of the core material being coated; and spherical alumina particles dispersed in the resin coating film.

The agitating screws 18 are respectively housed in the first space 20 and the second space 21. The longitudinal direction of the agitating screws 18 is parallel with the longitudinal direction of the container tank 17, the developing roller 15, and the photosensitive drum 8. The agitating screws 18 are disposed in a manner to be rotatable about an axis. As a result of rotation of the agitating screws 18 about the axis, the toner 36 and the magnetic carrier get agitated, and the developer 26 is transported along the axis.

In the illustrated example, the agitating screw 18 in the first space 20 transports the developer 26 from the above-described one end toward the other end. The screw 18 in the second space 21, on the other hand, transports the developer 26 from the other end to the one end.

According to the above-described arrangement, the developer feed part 14 transports the toner 36 that has been fed to one end of the first space 20 toward the other end while agitating it 36 with the magnetic carrier, and further transports them from the other end to the one end of the second space 21. The developer feed part 14 agitates the toner 36 and the magnetic carrier in the second space 21 and supply or feed them to the outer surface of the developing roller 15 while transporting them in the axial direction.

The casing 25 is formed into a box shape and is attached to the container tank 17 of the developer feed part 14 so as to cover the developing roller 15 and the like together with the container tank 17. There is provided an opening 25a in that portion of the casing 25 which lies opposite to the photosensitive drum 8.

The metering blade 16 is formed into a flat plate shape and is provided between the photosensitive drum 8 and that end of the container tank 17 which lies closer to the photosensitive drum 8. In other words, the metering blade 16 is disposed in a space, as seen in the direction of rotation of a developing sleeve 32 which is to be described hereinafter, between the container tank 17 and the photosensitive drum 8. The metering blade 16 is mounted on the container tank 17 in a state projecting from the container tank 17 toward the developing roller 15, and is also mounted on the casing 25 in a state in which a space is secured to the outer surface of the developing sleeve 32. The metering blade 16 functions to scrape into the container tank 17 that developer 26 on the outer surface of the developing sleeve 32 which exceeds a predetermined thickness to thereby make the developer 26 on the outer surface of the developing sleeve 32 to be transported to the developing region 31 to a desired thickness.

The developing roller 15 is formed into a columnar shape and is disposed between the second space 21 and the photosensitive drum 8 and near the above-described opening 25a. The developing roller 15 is parallel with both the photosensitive drum 8 and the container tank 17. The developing roller 15 is disposed at a distance to the photosensitive drum 8. The space between the developing roller 15 and the photosensitive drum 8 forms a developing region 31 in which the toner 36 of the developer 26 is adsorbed to the photosensitive drum 8 to thereby obtain a toner image by developing the electrostatic latent image. In the developing region 31 the developing roller 15 and the photosensitive drum 8 lie opposite to each other.

The developing roller 15 is provided, as shown in FIG. 2, with the columnar core metal 33a, a cylindrical magnet roller (also referred to as a magnet body) 33, and the above-described developing sleeve 32 as a non-magnetic cylindrical body. The core metal 33a is disposed such that the longitudinal direction thereof lies parallel with the longitudinal direction of the photosensitive drum 8 and is fixed to the casing 25 in a manner not to rotate.

The magnet roller 33 is made of a magnetic material into a cylindrical shape and is provided with a plurality of stationary magnetic poles. The magnet roller 33 is fixed to the outer surface of the core metal 33a in a manner not to rotate.

The stationary magnetic poles are elongated bar-shaped magnets, and are attached to the roller main body 33b of the magnet roller 33. The stationary magnetic poles are elongated along the longitudinal direction of the roller main body 33b, i.e., the developing roller 15, of the magnet roller 33 and are formed along the entire length of the roller main body 33b of the magnet roller 33. The magnet roller 33 having the above-described construction is housed in the developing sleeve 32.

One of the stationary magnet pole lies opposite to the above-described agitating screw 18 and generates a magnetic force on an outer surface of the developing sleeve 32, i.e., the developing roller 15. As a consequence, the developer 26 in the second space 21 of the container tank 17 will be adsorbed into the outer surface of the developing sleeve 32.

The other of the stationary magnetic poles lies opposite to the above-described photosensitive drum 8 and generates a magnetic force on an outer surface of the developing sleeve 32, i.e., the developing roller 15, thereby forming a magnetic field between the developing sleeve 32 and the photosensitive drum 8. This stationary magnetic pole is arranged to transfer or hand over the toner 36 of the developer 26 that has been adsorbed into the outer surface of the developing sleeve 82 to the photosensitive drum 8 as a result of forming a magnetic brush with the above-described magnetic field.

Further, the magnet roller 33 is provided, aside from above-described two stationary magnetic poles, with a stationary magnetic pole which serves to transfer the developer 26, which is before developing, from the containing tank 17 of the developer feed part 14 to the developing region 31 or which serves to transfer the developed developer 26 from the developing region 31 to the container tank 17.

Once the developer 26 has been adsorbed into the outer surface of the developing sleeve 32, the above-described stationary magnetic pole, i.e., the magnet roller 33 causes the magnetic carrier of the developer 26 to overlap in a plurality of numbers along the magnetic line in which the stationary magnetic pole is generated so that the magnetic carrier is vertically disposed or formed on the outer surface of the developing sleeve 32. The state in which the magnetic carrier is kept vertically disposed on the outer surface of the developing sleeve 32 is called vertical disposition of the magnetic carrier on the outer surface of the developing sleeve 32. Then, the toner 36 gets adsorbed into the vertically disposed magnetic carrier. In other words, the developing sleeve 32 adsorbs the developer 26 on the outer surface of the magnet roller 33 by means of the magnetic force.

As shown in FIG. 2, the developing sleeve 32 is formed into a cylindrical shape, and is disposed so as to be rotatable about an axis in a state in which the magnet roller 33 is included (housed) therein. The developing sleeve 32 is rotated so that the inner circumferential surface thereof sequentially lies opposite to the stationary magnetic pole. The developing sleeve 32 is made of a non-magnetic material such as aluminum alloy, stainless steel (SUS), and the like.

In this embodiment, the developing sleeve 32 has a multiplicity of recesses of random elliptical shape on its outer surface. The random recesses of elliptical shape are, of course, formed from the outer surface of the developing sleeve 32, and include those the longitudinal direction of which lies along the axial direction of the developing sleeve 32 and those the longitudinal direction of which lies along the circumferential direction of the developing sleeve 32. The recesses the longitudinal direction of which lies along the axial direction of the developing sleeve 32 are larger in number than the recesses the longitudinal direction of which lies along the circumferential direction of the developing sleeve 32. In addition, the length in the longitudinal direction of each recess (longitudinal diameter) is above 0.05 mm and below 0.3 mm, and the width (lateral diameter) thereof is above 0.02 mm and below 0.1 mm.

The recesses are formed in the following manner. Raw pipe which constitutes the developing sleeve 32 is positioned in a rotary magnetic field together with a media made of relatively large pieces of cut wire. The cut wire is obtained by cutting a metallic wire into short pieces. The media is made of a magnetic material such as austenitic stainless steel, martensitic stainless steel, and the like and is formed into columnar shape of short pieces of wires each having an outside diameter of above 0.5 mm and below 1.2 mm and the L/D is above 4 and below 10 where L is a total length and D is an outside diameter. The media is then rotated by the rotary magnetic field while revolving about the raw pipe so that the media is caused to collide with the outer surface of the raw pipe.

In this manner, the recesses are formed by colliding the media with the raw pipe in a manner similar to the conventional blasting method. When the developing sleeve 32 has a multiplicity of random recesses of elliptical shape on the outer surface thereof, the outer surface becomes the one having recesses and projections at rough pitches. As a result, there will be formed thick or heavy vertical disposition or formation of magnetic carrier having a root in the respective recesses which are difficult of slipping of the developer 26, and the recesses are hard of wearing. In this manner, it is possible to obtain a stable and good image free from irregularities for a long period of time.

The development device 13 according to the above arrangement is capable of sufficiently agitating the toner 36 and the magnetic carrier at the developer feed part 14, and the agitated developer 26 is then adsorbed into the outer surface of the developing sleeve 32. The development device 13 then transports the developer 26 that has been adsorbed into the developing sleeper 32 toward the developing region 31 as a result of rotation of the developing sleeve 32.

Then, the development device 13 scrapes the developer 26 that has exceeded the desired thickness by means of the metering blade 16. The developer that has attained the desired thickness is thus caused to be adsorbed into the photosensitive drum 8. In this manner, the development device 13 carries the developer 26 on the developing roller 15 for further transporting to the developing region 31. The electrostatic latent image on the photosensitive drum 8 is developed to thereby form the toner image.

Then, the development device 13 transports the developer 26 that has been developed, to the containing tank 17 and is released into the containing tank 17. Further, the developer 26 that has been stored into the containing tank 17 is once again agitated in the second space 21 with the other developer 26 for reuse in the developing of the electrostatic latent image on the photosensitive drum 8.

As shown in FIG. 3, the developer feed apparatus 35 is provided with a toner container 40 as a powder container, a transportation tank 41, a conveying screw 42 as a conveying device, a suction pump 43 as a suction device or a suction means, a piping part 44, a connecting pipe 45, a discharge pipe 46, an open/close device 47, and a control device 48 as a control means. The toner container 40 has the internal space closed and contains therein the toner 36 of the above-described developer 26. The toner container 40 is closed in its inner space for containing therein the toner 36 as the developer 26. The toner container 40 is disposed on an upper part of the transportation tank 41.

The transportation tank 41 is formed into a rectangular box shape the longitudinal direction of which is parallel with the above-described transportation tank 41, the developing roller 16, and the like. The transportation tank 41 is provided therein with a space and is fixed to the inside of the cartridge case in a state in which the longitudinal direction thereof is parallel with the horizontal direction. The transportation tank 41 is disposed in an upper part of the container tank 17.

On one end which is located on the right side of the transportation tank 41 as seen in the longitudinal direction in FIG. 3, there is provided an inlet 49 and, on the other end which is located on the left side as seen in the longitudinal direction in FIG. 3, there is provided an outlet 50 and a suction port 51. In other words, the suction port 51 and the outlet 50 are away from the inlet 49. The inlet 49, the outlet 50, and the suction port 51 are openings which communicate the inside and the outside of the transportation tank 41. The inlet 49 receives the supply of the toner 36 in the toner container 40, and the outlet 50 is used to discharge the toner 36 in the transportation tank 41 to the outside.

Among the outside walls of the transportation tank 41, the wall 41a which is located in an upper part as seen in FIG. 3 is provided with a partition (or separating) wall 52, a proximity wall 53, and a step 54 which connects these walls 52, 53 together. The partition wall 52 is disposed in the central portion as seen in the longitudinal direction of the wall 41a and is located at a distance from the conveying screw 42. Therefore, the partition wall 52 forms a space K between the partition wall 52 and the conveying screw 42. In the illustrated example, the thickness of the space K, i.e., the distance between the conveying screw 42 and the partition wall 52 is made larger than the outside diameter of the conveying screw 42.

The proximity wall 53 is provided in both longitudinal end portions of the wall 41a and is disposed in close proximity to the conveying screw 42. For this reason, the step 54 is provided between the partition wall 52 and the proximity wall 53.

Further, the inlet 49 and the suction port 51 are provided in the partition wall 52. The outlet 50 lies at a distance to the wall 41a and is provided in a wall 41b which is located at a lower portion as seen in FIG. 3. In other words, the suction port 51 is apart from the outlet 50. In addition, the outlet 50 is disposed in a position which lies opposite to the proximity wall 53. In other words, at the other end of the transportation tank 41, the outlet 50 is disposed at a position which is closer to the other end of the transportation tank 41 than is the suction port 51.

The suction port 51 is further provided with a filter 55 that restricts the toner 36 from passing through but allows the gas (air) to pass therethrough. In other words, the filter 55 allows the suction pump 43 to suck the gas into the transportation tank 41 and restricts the toner 36 in the transportation tank 41 to leak outside through the suction port 51.

The conveying screw 42 is housed in the transportation tank 41 so as to be rotatable about the axis, and is disposed between the proximity wall 53 of the wall 41a positioned at the upper part and the wall 41b positioned at the lower part such that the longitudinal direction of the conveying screw 42 lies parallel with the transportation tank 41. The conveying screw 42 is rotated about its axis by a driving source such as an electric motor and the like (not illustrated).

The conveying screw 42 is provided with a bar-shaped shaft 56, and a vane 57 which projects out of the outer surface of the shaft so as to be elongated spirally. As a result of rotation about the axis by means of the driving source, the conveying screw 42 agitates the toner 36 supplied through the inlet 49 into the transportation tank 41, and transports the toner 36 from the inlet 49 toward the outlet 50.

The suction pump 43 is disposed above the transportation tank 41 and is provided with a cylinder main body 58 of a bottomed cylindrical shape, a piston 59, and a piston driving device 60. The cylinder main body 58 is integrally provided with a bottom 61 made of a circular disc, and a cylindrical part 62 which extends vertically upward from the peripheral edge of the bottom 61. The bottom 61 is provided with a through hole 63 penetrating through the bottom 61. The cylindrical part 62 is integrally provided with a small-diameter part 62a which is in communication with the external edge of the bottom 61, and a large-diameter part 62b which is larger than the small-diameter part 62a in both the inner diameter and outer diameter and is in communication with the small-diameter part 62a.

The piston 59 is provided with a piston head 64 of a circular disk shape, and a piston rod 65 which is disposed to extend vertically from the piston head 64. The piston head 64 is formed into an outer diameter that is the same as the bottom 61, and is housed in the cylinder main body 58 such that the piston head 64 is parallel with the bottom 61 and that the outer edge is slidable relative to the inner circumference of the small-diameter part 62a of the cylindrical part 62. The piston head 64, i.e., the piston 59 is disposed movably along the axis of the cylinder main body 58.

The piston driving device 60 operates to move the piston 59 relative to the cylinder main body 58. When the piston 59 is moved by the piston driving device 60 in a direction away from the bottom 61, there is generated a negative pressure which sucks the gas in the transportation tank 41. When the piston 59 is moved in a direction toward the bottom 61, there is generated a positive pressure which delivers the gas into the transportation tank 41.

In this manner, the suction pump 43 is so arranged that, by moving the piston 59 away from the bottom 61, the gas in the transportation tank 41 can be sucked. It is also so arranged that, by moving the piston 59 toward the bottom 61, the gas can be fed into the transportation tank 41.

In addition, the suction pump 43 is so arranged that, when the piston head 64 of the piston 59 is positioned in the large-diameter part 62b, there will be generated a clearance between the inner circumference of the large-diameter part 62b and the outer edge of the piston head 64, so that the gas outside the transportation tank 41 is allowed to flow into the cylinder main body 58, i.e., into the transportation tank 41. In this manner, the suction pump 43 is so arranged that, by moving the piston 59 in a direction away from the bottom 61, the gas in the transportation tank 41 is continuously sucked and thereafter that the pressure in the transportation tank 41 is capable of being made equal to the pressure outside the transportation tank 41.

In addition, the suction pump 43 is so arranged that, by appropriately changing the position of the piston 59 relative to the cylinder main body 58, the pressure in the cylinder main body 58, i.e., in the transportation tank 41 can be changed. In other words, the suction pump 43 has a construction in that the pressure to be generated in the transportation tank 41 can be freely varied. Further, the suction pump 43 is so arranged that, by changing the moving speed of the piston 59 relative to the cylinder main body 58, the time at which the pressure is generated in the transportation tank 41 can be varied. In other words, the suction pump 43 is so constructed that the time of generating the pressure in the transportation tank 41 can be varied.

The piping part 44 is formed into a pipe shape as a whole, and a flow passage for allowing the toner 36 to flow therethrough is formed inside. The piping part 44 is provided with a tube 66 and a stationary piping member 67. The tube 66 is made of an elastic material such as rubber and is formed into a cylindrical shape and integrally with the toner container 40. In other words, the tube 66 is elastically deformable and the toner 36 in the toner container 40 is supplied to the inside of the tube 66.

The stationary piping member 67 is provided with a main body part 68 of a box shape the inside of which is hermetically sealed, and cylindrical projections 69 which project from the main body part 68 and which are integrally formed with the transportation tank 41 in the illustrated example. The projections 69 are each sufficiently smaller in inner diameter than the inner diameter of the main body part 68. Further, the inner diameters of the projections 69 are smaller than the inner diameter of the tube 66. In addition, one of the projections 69 is integrally formed with the wall 41a of the transportation tank 41 and is in communication with the neighborhood of the inlet 49. The other of the projections 69 is connected to the other end of the tube 66.

According to the above-described arrangement, the piping part 44 is provided with the tube 66 and the projections 69 the inner diameters of both are small, and the main body part 68 the inner diameter of which is larger than the above-described inner diameters. In the illustrated example, the cross-sectional area of the space (corresponding to the flow passage for the toner 36 to flow) in the tube 66 and the projections 69 is below 1/10 of the diameter of the cross-sectional area of the space (corresponding to the flow passage for the toner 36 to flow) in the main body part 68. The tube 66 and the projections 69 are connected to the toner container 40 and the transportation tank 41, respectively, and constitute the small-diameter section as claimed. The main body part 68 is provided between the projections 69, as the claimed small-diameter sections, and constitutes the large-diameter section as claimed.

The connecting pipe 45 is made of an elastic material such as rubber and is formed into a cylindrical shape. In other words, the connecting pipe 45 is elastically deformable. The connecting pipe 45 is fixed, at one end, to the neighborhood of the through hole 63 provided at the bottom 61 of the suction pump 43 and is fixed, at the other end, to the surrounding of the suction port 51 provided in the transportation tank 41. In this manner, the connecting pipe 45 connects the suction pump 43 and the transportation tank 41 together. The suction pump 43 is disposed outside the transportation tank 41 because it is connected to the transportation tank 41 by means of the connecting pipe 45.

The discharge pipe 46 is made of an elastic material such as rubber and is formed into a cylindrical shape. In other words, the discharge pipe 46 is elastically deformable. The discharge pipe 46 is fixed, at one end, to the neighborhood of the outlet 50 and is fixed, at the other end, to the neighborhood of the feed port 37 which is provided in the containing tank 17 of the development device 13.

The open/close device 47 is provided with: a pair of pinching or holding members 70 which are disposed to be capable of moving toward and away from each other; and an open/close drive source 71 as an open/close device. The pinching members 70 are positioned opposite the central part of the discharge pipe 46. The open/close drive source 71 operates to move the pinching members 70 toward and away from each other. The pinching members 70 are so arranged that, when they arc moved toward each other, they pinch the discharge pipe 46 between the pinching members 70 to crush the discharge pipe 46, thereby keeping the discharge pipe 46 hermetically sealed. When the pinching members 70 are moved away from each other, the discharge pipe 46 is released (i.e., opened to passage). The open/close drive source 71 thus operates to cause the discharge pipe 46 to be open to passage or closed to passage. In other words, the open/close drive source 71 makes the discharge pipe 46 to be capable of being opened or closed.

The control device 48 is a computer provided with well-known parts such as RAM, ROM, CPU, and the like. The control device 48 performs the controlling of the entire image forming apparatus 1, i.e., the process cartridges 6Y, 6M, 6C and 6K. Needless to say, the control device 48 is connected to the conveying screw 42, suction pump 43, open/close device 47, and the like to control their operations, thereby performing the control of the developer feed apparatus 35.

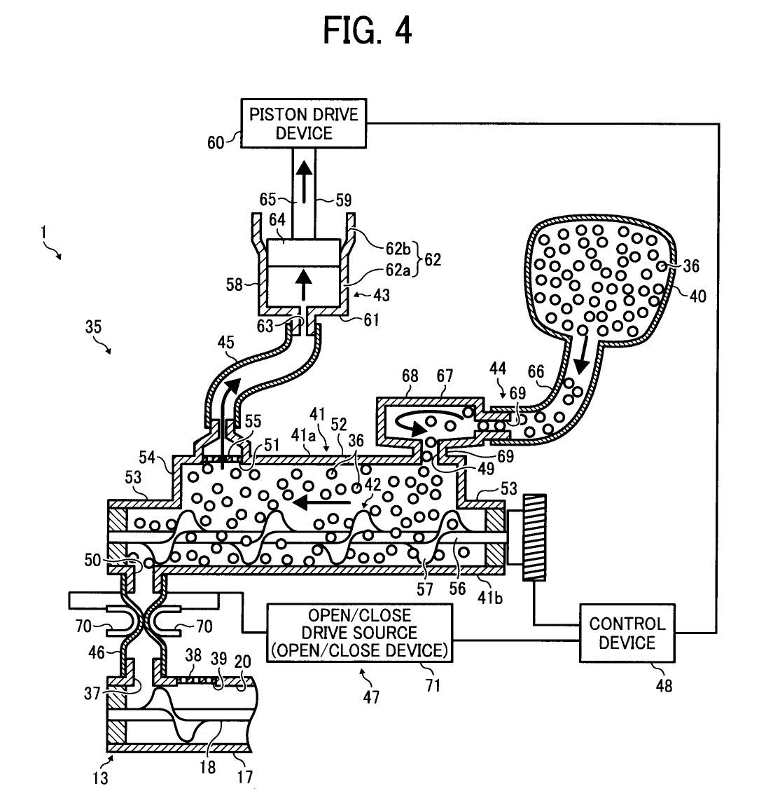

When the toner 36 in the toner container 40 is to be introduced to the transportation tank 41, the control device 48 operates, as shown in FIG. 4, to rotate the conveying screw 42 about the axis. In a state in which the discharge pipe 46 is caused to be closed by the open/close drive source 71, the piston 59 of the suction pump 43 is moved in the direction away from the bottom 61 of the cylinder main body 58. The suction pump 43 is thus caused to suck the gas in the transportation tank 41. Then, the gas in the toner container 40 is sucked by the suction pump 43 to thereby cause the toner 36 in the toner container 40 to be sucked into the transportation tank 41.

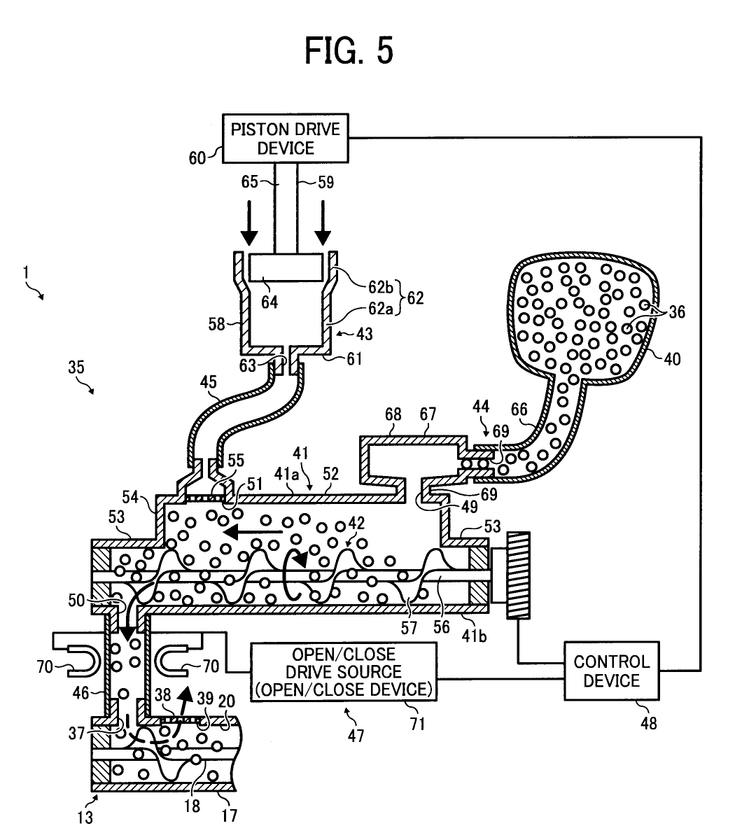

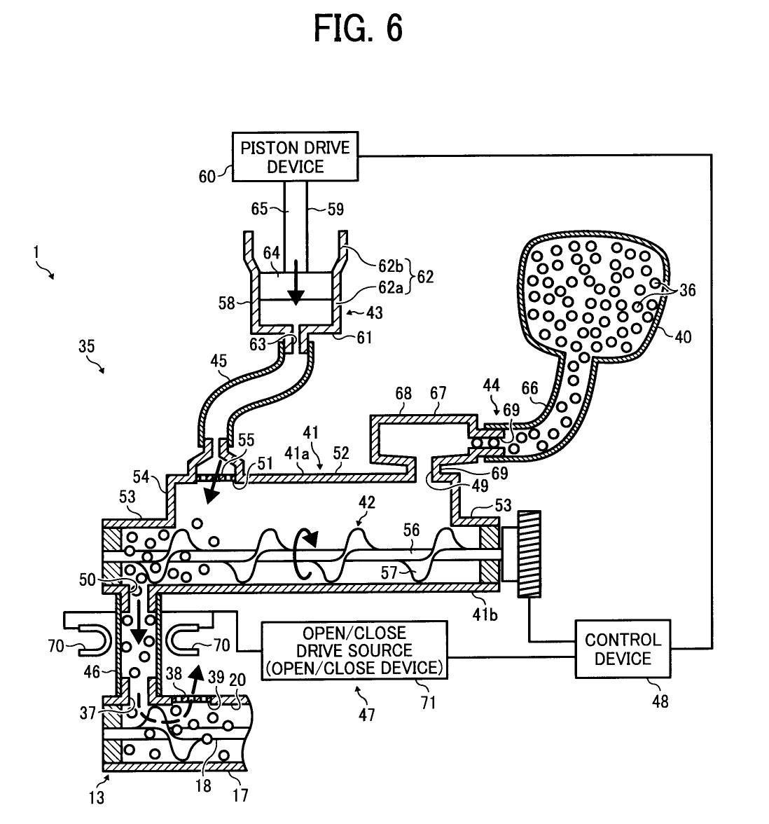

When the toner 36 in the transportation tank 41 is introduced to the container tank 17 of the development device 13, the control device 48 operates to rotate the conveying screw 42 about the axis, as shown in FIGS. 5 and 6. In a state in which the discharge pipe 46 is left open by the open/close drive source 71, the piston 59 of the suction pump 43 is moved in the direction toward the bottom 61 of the cylinder main body 58, to thereby cause the suction pump 43 to supply the gas into the transportation tank 41. As a result, the toner 36 in the transportation tank 41 is discharged from the outlet 50 so as to be supplied to the container tank 17 of the development device 13 through the discharge pipe 46.

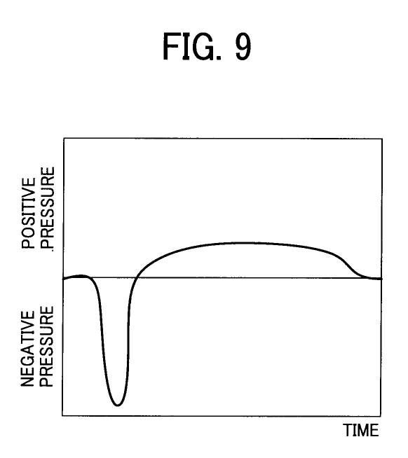

As shown in FIG. 9, the control device 48 operates to make the suction time shorter than the discharge time, the suction time being the time in which the gas in the transportation tank 41 is sucked by the suction pump 43 in a state in which the discharge pipe 46 is kept closed by the open/close drive source 71 to thereby stick the toner 36 into the transportation tank 41, and the discharge time being the time in which the gas is fed into the transportation tank 41 by the suction pump 43 in a state in which the discharge pipe is kept open by the open/close drive source 71 to thereby discharge the toner 36 out of the transportation tank 41.

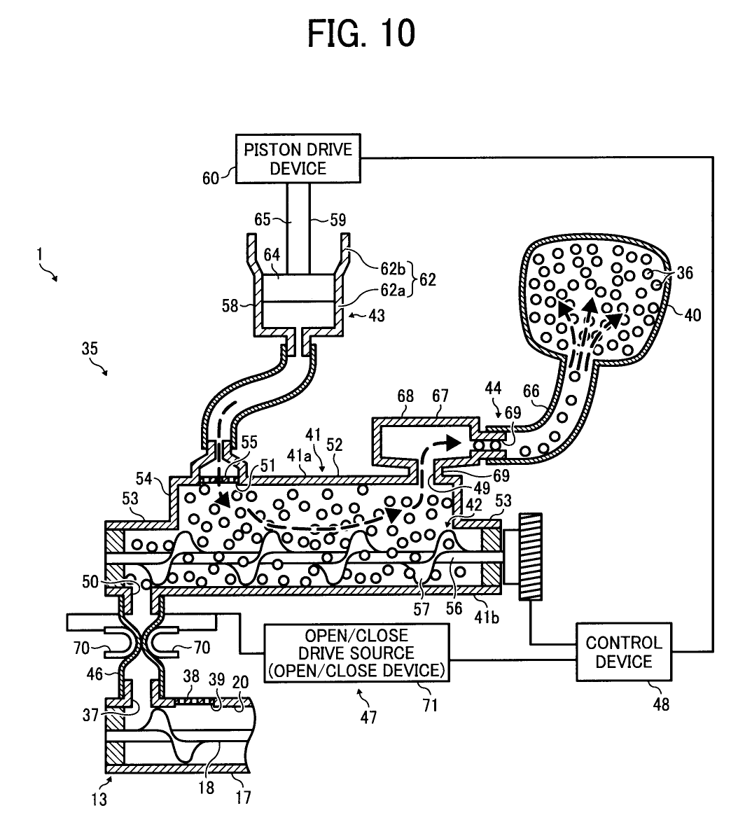

As shown in FIG. 10, the control device 48 causes the suction pump 43 to feed the gas into the transportation tank 41 in a state in which the discharge pipe 46 is kept closed by the open/close drive source 71, e.g., right after the power of the image forming apparatus 1 is switched on. As a result, the gas sent into the transportation tank 41 blows off the toner 36 adhered to the filter 55 and the toner 36 is also sent to the toner container 40.

The developer feed apparatus 35 supplies or feeds the toner 36 in the toner container 40 to the container tank 17 of the development device 13 in the following manner.

As shown in FIG. 3, the control device 48 operates in the following manner, i.e., the piston 59 of the suction pump 43 is kept closest to the bottom 61 of the cylinder main body 58, then the conveying screw 42 is rotated about the axis and, as shown in FIG. 8, and the piston 59 of the suction pump 43 is moved away from the bottom 61 in a state in which the discharge pipe 46 is kept closed by the open/close drive source 71.

Then, as shown in FIG. 4, the gas is sucked by the suction pump 43 into the transportation tank 41 and, as shown in FIG. 9, the pressure in the transportation tank 41 lowers and, as a consequence, the toner 36 is sucked into the transportation tank 41 together with the gas in the toner container 40. At this time, since the cross-sectional area of the tube 66 and that of the main body 68 of the stationary pipe 67 are different from each other by about more than 10 times, the gas and the toner 36 that entered the main body 68 of the stationary pipe 67 from the tube 66 get scattered in the main body 68. In this manner, it is possible to loosen the toner 36.

Then, when the piston 59 of the suction pump 43 is positioned in the large-diameter part 62b, the gas outside the transportation tank 41 flows into the transportation tank 41 through the cylinder main body 58 of the suction pump 43 and the suction port 51. As a result, the pressure in the transportation tank 41 becomes equal to the pressure outside the transportation tank 41. Then, the flow of the toner 36 from the toner container 40 into the transportation tank 41 stops and also, due to the rotation of the conveying screw 42, the toner 36 in the transportation tank 41 moves toward the outlet 50.

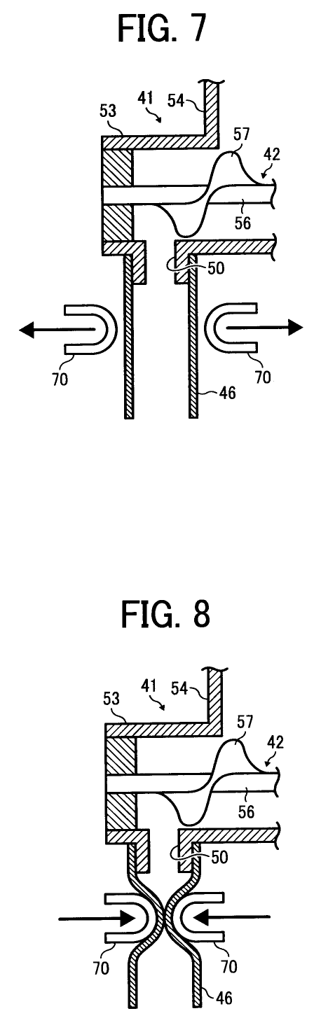

Thereafter, as shown in FIGS. 5 and 7, by opening the discharge pipe 46 by means of the open/close drive source 71, the piston 59 of the suction pump 43 is moved in the direction toward the bottom 61. As a result, as shown in FIG. 6, the suction pump 43 supplies the gas into the transportation tank 41. Due to the gas, the toner 36 in the transportation tank 41 is discharged out of the transportation tank 41 through the outlet 50 into the container tank 17 of the development device 13. At this time, the gas fed into the container tank 17 is discharged through the discharge port 39 out of the container tank 17. In this manner, the developer feed apparatus 35 supplies the toner 36 to the container tank 17 of the development device 13.

The developer recovery unit 34 is provided with a toner transporting coil 72, a developer recovery apparatus 73 as a powder transporting apparatus, and a recovery container 75. The toner transporting coil 72 is disposed below the process cartridges 6Y, 6M, 6C and 6K. The toner transporting coil 72 is constituted by disposing a rotatable flexible coil in a pipe generally called an auger. The toner transporting coil 72 transports, to a toner collecting container 74, the residual toner 36 that remains on the photosensitive drum 8 and the like after development as a powder that has been removed from the photosensitive drum 8 of each of the process cartridges 6Y, 6M, 6C and 6K.

Since the developer recovery apparatus 73 is substantially equal in construction to the developer feed apparatus 35, the same reference numerals are attached to the same parts and description thereof is omitted. The developer recovery apparatus 73 is disposed under the apparatus main body 2 and comprises the toner collecting container 74, transportation tank 41, suction pump 43 as the suction device, and the like.

The toner collecting container 74 contains therein the toner 36 which remains after development and which has been transported by the toner transporting coil 72. The suction pump 43, i.e., the developer recovery apparatus 73 delivers the toner 36 remaining in the toner collecting container 74 after development by sucking it into the transportation tank 41 for subsequent discharging to the toner collecting container 75.

The collecting container 75 is detachably mounted on the apparatus main body 2 and contains therein the toner 36 from the developer recovery apparatus 73, the toner 36 being residual after development.

The developer recovery apparatus 73, i.e., the developer recovery unit 34 supplies to the recovery container 75 the toner 36, as the powder, that has been removed from the photosensitive drum 8 and the like of the process cartridges 6Y, 6M, 6C and 6K, the toner 36 being the one that remained after the development processing.

The above-described image forming apparatus 1 forms an image on a piece of printing paper 7 as described in detail hereinafter. First, the image forming apparatus 1 rotates the photosensitive roller 8 to uniformly charge the outer surface of the photosensitive drum 8 by means of the charging roller 9. By irradiating laser beam on an outer surface of the photosensitive drum 8, electrostatic latent image is formed on the outer surface of the photosensitive drum 8. Then, once the electrostatic latent image is positioned in the developing region 31, the toner 36 of the developer 26 that has been adsorbed into the outer surface of the developing sleeve 32 of the development device 13 will be adsorbed into the outer surface of the photosensitive drum 8. The electrostatic latent image is developed to thereby form a toner image on the outer surface of the photosensitive drum 8.

Then, the image forming apparatus 1 transfers to the recording paper 7 the toner image formed on the outer surface of the photosensitive drum 8 when the recording paper 7 transferred by the paper feeding roller 24 and the like of the paper feed unit 3 is positioned between the photosensitive drum 8 of the process cartridges 6Y, 6M, 6C and 6K and the transporting belt 29 of the transfer unit 4. The image forming apparatus 1 deposits the toner image to the recording paper 7. In this manner, the image forming apparatus 1 forms a color image on the recording paper 7.

According to this embodiment, the gas in the transportation tank 41 is sucked to thereby suck the toner 36 from the toner container 40 into the transportation tank 41. In other words, negative pressure is generated in the transportation tank 41 in order to suck the toner 36 into the transportation tank 41. Further, as a means for generating the negative pressure in the transportation tank 41, there is provided a suction pump 43 outside the transportation tank 41. As a result, the heat to be generated by the suction pump 43 can be prevented from being transmitted to the toner 36. Further, since the toner 36 is sucked into the transportation tank 41 by negative pressure, the toner can be sucked into the transportation tank 41 without grinding the toner 36. Therefore, while minimizing the thermal stress to be given to the toner 36, the toner 36 can be transported.

In addition, the inlet 49 is disposed in one end of the transportation tank 41, and the suction port 51 is disposed in the other end of the transportation tank 41. Further, both the inlet 49 and suction port 51 are positioned in the wall 41a that is positioned on an upper part of the transportation tank 41. Therefore, the toner once sucked through the inlet 49 can be prevented from getting into the suction port 51, thereby surely keeping the toner 36 inside the transportation tank 41. It is thus possible to surely suck the toner 36 into the transportation tank 41.

The wall 41a positioned at an upper portion is provided with the partition wall 52 at a distance to the conveying screw 42, and the space K is formed above the conveying screw 42 in the transportation tank 41. Therefore, the toner 36 can be stored in the space K. In this manner, by providing the space for storing the toner in the transportation tank 41, the toner 36 can be supplied by an appropriate amount each time without the possibility of coagulation of the toner 36 in the transportation tank 41.

The transportation tank 41 is provided with the wall 41b at the other end of, and at the bottom of, the transportation tank 41. Therefore, the toner 36 in the transportation tank 41 can surely be discharged through the outlet 50 out of the transportation tank 41. In addition, since the outlet 50 is disposed at a position which is closer to the end than the suction port 51 is, the toner 36 in the outside of the transportation tank 41 can be prevented from getting sucked through the outlet 50 at the time of sucking the gas in the transportation tank 41 through the suction port 51. Therefore, the toner 36 in the toner container 40 can surely be sucked into the transportation tank 41.

Since the proximity wall 53 which is close to the conveying screw 42 is provided above the outlet 50, there is secured, above the outlet 50, no space which is available for storing the toner 36 therein. In this manner, due to the absence above the outlet 50 of the space capable of storing therein the toner 36, the toner 36 to be accumulated or stored in the outlet 50 can be reduced. The fluctuation in the amount of transportation of the toner 36 can thus be reduced.

The suction port 51 is provided with the filter 55 and, therefore, the toner 36 and the suction pump 43 can be separated form each other. Since the toner 36 will not be brought into direct contact with the suction pump 43, it becomes possible to apply grease and the like to the suction pump 43. As a result, the suction pump 43 can further be reduced in driving power and be prolonged in lifetime.

The transportation tank 41 and the toner container 40 are disposed as separate members and are connected to each other by the piping part 44. In addition, the piping part 44 is provided with the tube 66 and the projections 69 as a small-diameter part as well as the stationary pipe 67 as a large-diameter part. Therefore, when the toner 36 passing through the piping part 44 enters the stationary pipe 67 through the projection 69, the toner 36 gets dispersed inside the piping part 44. It becomes possible to loosen (lower the bulk density of) the toner 36 which is likely to become hardened after a lapse of time, and to minimize the reverse flow of the toner 36 without the use of mechanical valve, thereby enabling the transportation of highly aggregative toner 36.

The suction pump 43 is capable of sucking the gas in the transportation tank 41 and is also capable of feeding or supplying the gas into the transportation tank 41. In other words, the suction pump 43 can cause the gas to flow to and from the transportation tank 41 in both directions of a positive pressure direction and a negative pressure direction. It is thus possible to clean the filter 55 of possible clogging by the toner 36 by the reversal of flow directions, resulting in a long life of the filer 55.

The pressure in the transportation tank 41 is made equal to the outside pressure after the suction pump 43 has sucked the gas in the transportation tank 41. Therefore, the transportation tank 41 can surely be hermetically sealed and thus the toner 36 can be prevented from leaking out of the transportation tank 41. As a result, the fluctuation in the amount of transportation of the toner 36 can be reduced.

The discharge pipe 46 which transports the toner 36 and which connects the developer feed apparatus 35 and the developer recovery apparatus 73 with other devices on the downstream side is made of a resilient material. Therefore, the developer feed apparatus 35 and the developer recovery apparatus 73 can be completely hermetically sealed relative to the other devices. As a result, the toner 36 can be prevented from getting scattered.

The discharge pipe 46 can be hermetically sealed by crushing the discharge pipe 46 by means of the open/close device 47. Therefore, the developer feed apparatus 35 and the developer recovery apparatus 73 can be completely sealed relative to the other devices on the downstream side thereof. Therefore, there is no more possibility that the toner 36 gets splashed.

Further, it is so arranged that, when the image forming apparatus 1 is switched on, the discharge pipe 46 is hermetically sealed and the suction pump 43 sends the gas into the transportation tank 41. Therefore, it is possible to remove the toner 36 from the filter 55 and also to feed the gas into the toner container 40. As a result, it is also possible to loosen the toner 36 in the toner container 40. It follows that the toner 36 free from coagulation can be supplied.

In a state in which the open/close device 47 has left open the discharge pipe 46, the gas is supplied to the transportation tank 41 to thereby apply a positive pressure to the transportation tank 41. In this manner, while the filter 55 is washed back (cleaned), the gas penetrates into the space among particles of the toner 36 which is poor in flowability, thereby improving the flowability of the toner 36. As a result, the developer feed apparatus 35 and the developer recovery apparatus 73 which are long-lived and high-performance can be supplied.

In a state in which the open/close device 47 has closed the discharge pipe 46, the suction pump 43 sucks the gas in the transportation tank 41.

Therefore, it is possible to surely suck the powder in the toner container 40 to the transportation tank 41. Since the duration of time for the suction pump 43 to discharge the toner 36 out of the transportation tank 41 is longer than the duration of time for the suction pump 43 to suck the toner 36 into the transportation tank 41, the filter 55 can be prevented from getting clogged.

Since the pressure to be generated by the suction pump 43 is variable, the negative pressure can be increased when the negative pressure decreases as a result of, e.g., deterioration after the lapse of time and the like (i.e., the pressure at the time of negative pressure generation can be kept low). Therefore, the long-lived developer feed apparatus 35 and the developer recovery apparatus 73 can be supplied.

By making it possible to vary the pressure generating time of the suction pump 43, it becomes possible to widely cope with the toner 36 with different flowability and specific gravity, whereby it is possible to handle various kinds of toners 36.

By transporting the toner 36 with the conveying screw 42 having the helical vane 57, it becomes possible to transport the toner 36 by a little amount at a time.

It becomes possible to loosen the toner 36 and transport the toner 36 of low melting point without subjecting it to a thermal stress. As a result, there can be supplied an energy-saving developer feed apparatus 35 and the developer recovery apparatus 73 which can contribute to a high image quality.

It becomes possible to transport the toner 36 of poor flowability. The toner 36 can be transported efficiently, and the transportation of a toner of low-melting point and poor flowability which remains after developing, and the like becomes feasible.

Since the apparatus of this invention is provided with the developer feed apparatus 35 and the developer recovery apparatus 73, it becomes possible to loosen the toner 36 and to transport the toner 36 of low melting point without subjecting it to the thermal stress. It can thus be possible to provide the image forming apparatus 1 which is free from scattering of toner 36 as the powdery material and which is energy-saving and long-lived.

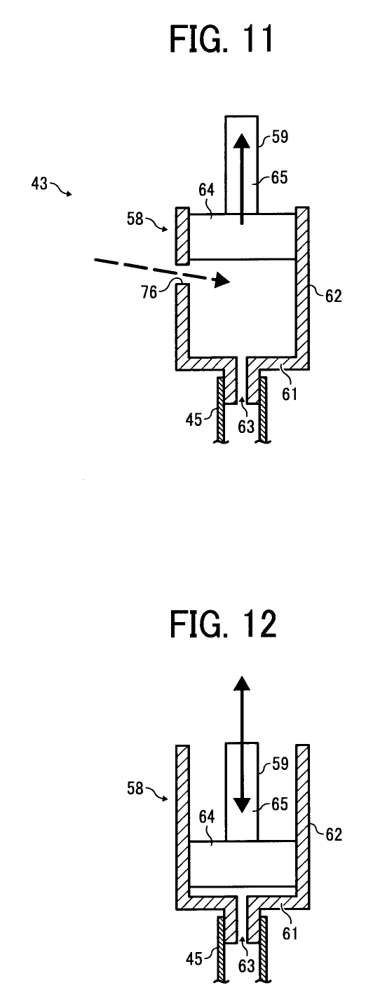

According to the above-described embodiment, the cylindrical part 62 of the cylinder main body 58 of the suction pump 43 is provided with a small-diameter part 62a and a large-diameter part 62b. When the piston 59 departs from the bottom 61 so as to be positioned in the large-diameter part 62b, the gas enters the transportation tank 41 through the cylinder main body 58. As a result, the pressure in the transportation tank 41 becomes equal to the pressure outside the transportation tank 41. However, in the invention, the following arrangement may also be employed. In other words, as shown in FIG. 11, the inside diameter and the outside diameter of the cylindrical part 62 of the cylinder main body 58 are formed uniform, and an opening 76 is formed in a position away from the bottom 61 of the cylindrical part 62. In this arrangement, when the piston 59 is away from the bottom 61, the gas enters the transportation tank 41 through the cylinder main body 58 so that the pressure in the transportation tank 41 becomes equal to the outside pressure.

Further, according to the invention, the following arrangement may also be employed as shown in FIG. 12. Instead of forming an opening 76 in the cylindrical part 62 of the cylinder main body 58, the inside diameter and the outside diameter of the cylindrical part 62 are formed uniform. Even if the piston 59 leaves the bottom 61, the gas does not enter the transportation tank 41 through the cylinder main body 58. Instead, the pressure in the transportation tank 41 may be kept lower than the outside pressure. In FIG. 12, the same reference numerals have been attached to those portions that are the same as the previous embodiments and the descriptions therefore have been omitted.

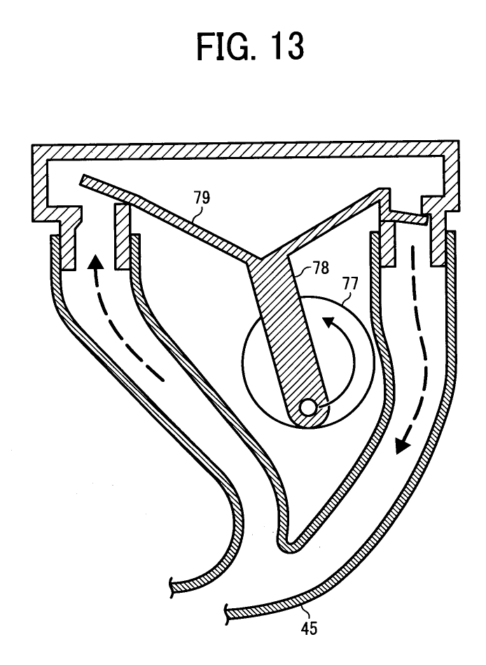

Further, in the invention, the suction pump 43 may alternatively be constituted as shown in FIG. 13. The suction pump 43 as shown in FIG. 13 is made up of: a driving disc 77 which is driven for rotation by a driving source; a coupling shaft 78 which is rotatably coupled to the outer edge of the driving disc 77; and a diaphragm 79 which is connected to the coupling shaft 78. The suction pump 43 as shown in FIG. 13 is so arranged that, when the transportation tank 41 is kept hermetically sealed, the driving disc 77 is rotated and the diaphragm 79 is pulled. As a result, the internal volume increases and the gas is expanded to thereby generate a negative pressure in the transportation tank 41. By returning the diaphragm 79, the gas is compressed so that a positive pressure can be applied to the transportation tank 41.

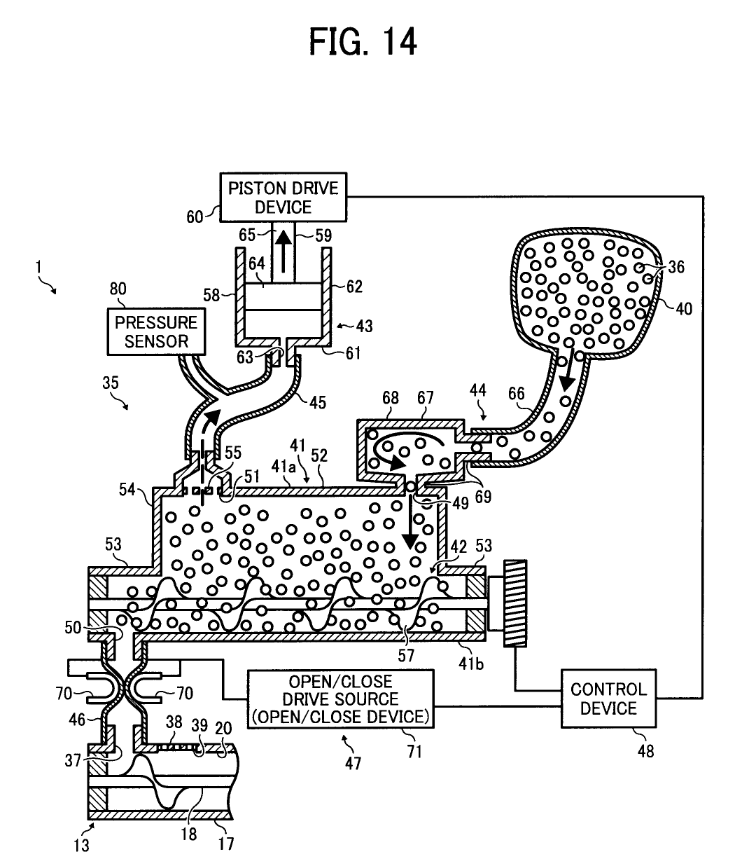

Further, the invention may alternatively be provided, as shown in FIG. 14, with a pressure sensor 80 as pressure detection means. In FIG. 14, the same reference numerals have been attached to those portions that are the same as the previous embodiments and the descriptions thereof have been omitted. In the example in FIG. 14, the pressure sensor 80 is attached to the connection pipe 45 to thereby detect the pressure in the connection pipe 45, i.e., the transportation tank 41. The information indicating the detected pressure is outputted to the (control device 48. In other words, the pressure sensor 80 is arranged to be capable of detecting the pressure to be generated, in the transportation tank 41, by the suction pump 43. Further, in the example shown in FIG. 14, the control device 48 controls the suction pump 43, based on the pressure in the transportation tank 41 as detected by the pressure sensor 80, so that the pressure in the transportation tank 41 becomes a predetermined pressure when the suction pump 43 suctions or delivers the gas.

According to this example, since there is provided a pressure sensor 80 that can detect the generated pressure in the suction pump 43, the lowering of the load, if any, due to deterioration after the lapse of time can be detected. Therefore, the necessary steps can be taken such as increasing the pressure and the like at the time of pressure decrease as a result of deterioration after the lapse of time.

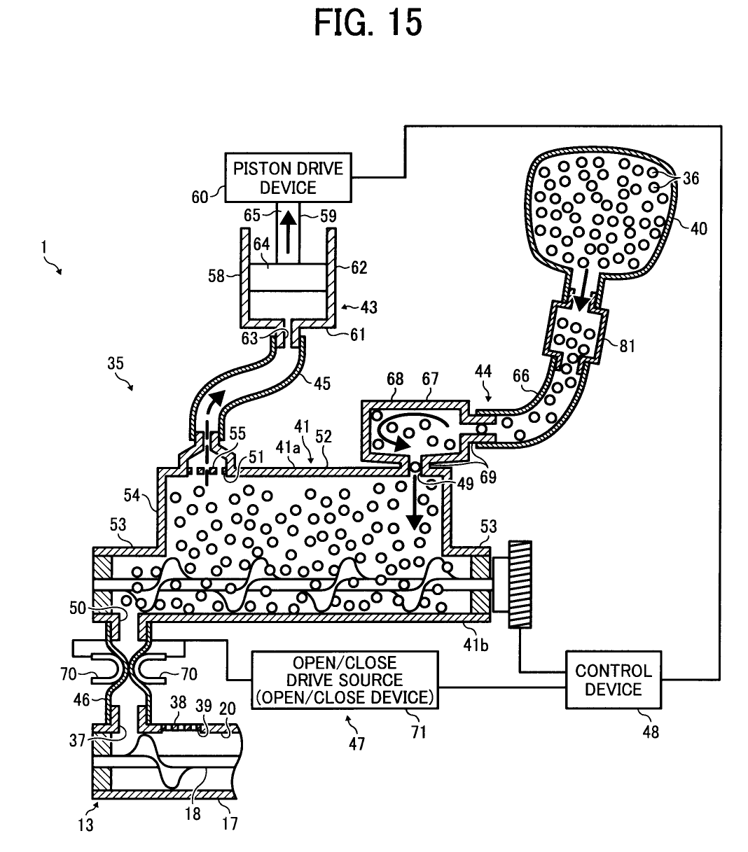

According to the invention, as shown in FIG. 15, the central part of the tube 66 may be provided with a large-diameter piping member 81 as a larger-diameter part, and the piping part 44 may be provided with a plurality of large-diameter parts. The large-diameter piping member 81 is formed into a cylindrical shape whose internal diameter and the outside diameter are larger than the tube 66. The cross-sectional area of the space inside the large-diameter piping member 81 is preferably more than 10 times the cross-sectional area of the space inside the tube 66.

According to the example in FIG. 15, the piping part 44 coupling the toner container 40 and the transportation tank 41 is provided with a plurality of large-diameter parts. The toner 36 can therefore be loosened at two steps or stages between the toner container 40 and the transportation tank 41. As a result, it becomes possible to transport even a highly coagulant toner 36.

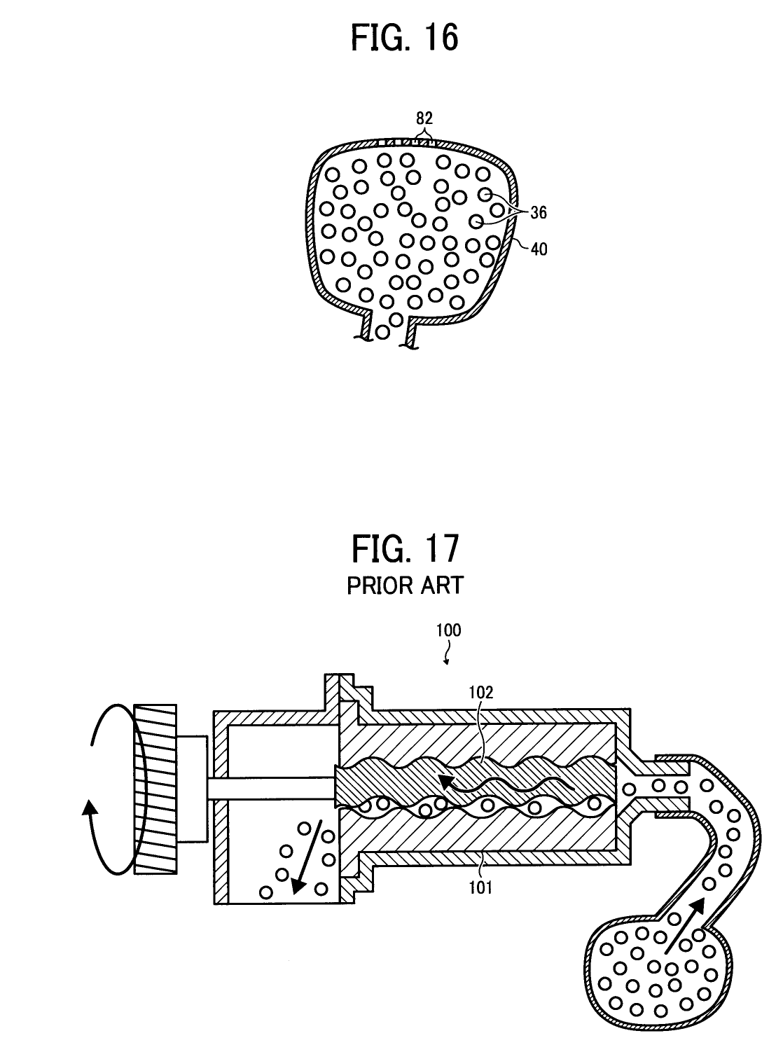

In addition, according to the invention, as shown in FIG. 16, small openings 82 may be formed in the toner container 40; it is not necessary to hermetically seal the toner container 40.

In addition, in the above-described examples, the developer feed apparatus 35 as the powder transporting apparatus transports only the toner 36 as the powder. This invention may also be so arranged to transport the developer which is made of the toner 36 as the powder and the magnetic carrier as the powder, or only the magnetic carrier as the powder may also be transported.

The image forming apparatus 1 of the above-described examples is provided with the process cartridges 6Y, 6M, 6C and 6K which are detachable to the apparatus main body 2. However, the invention serves the purpose if the image forming apparatus 1 is provided with the development device 13 and, therefore, the process cartridges 6Y, 6M, 6C and 6K are not necessarily required.

As has been described in detail hereinabove, the powder transporting apparatus according to the invention has the following advantages. In other words, preferably, the inlet is disposed in one of longitudinal ends of the transportation tank and the suction port is disposed in the other of the longitudinal ends thereof. Both the inlet and the suction port are disposed in a wall positioned in an upper part of the transportation tank.

According to this arrangement, the powder that has been sucked through the inlet can surely be sucked into the transportation tank. It is thus possible to prevent the powder from being introduced or guided into the suction device once again. In this manner, the powder can surely be sucked into the transportation tank.

In addition, the wall that is positioned in an upper part of the transportation tank is preferably provided with a partition wall that is disposed at a distance from the conveying device, whereby a space is formed between the partition wall and the conveying device.

According to the above arrangement, since the space is formed in an upper part of the conveying device in the transportation tank, the powder can be stored in the space. In this manner, by providing the upper part of the transportation tank with the space in which the powder can be kept stored, the powder can be supplied by an appropriate amount without the possibility of agglomeration in the transporting tank.

It is preferable that the outlet is provided in the wall which is positioned in the other of the longitudinal ends of the transportation tank. The wall is also positioned below the conveying device and is disposed at a position nearer to the other of the longitudinal ends of the transportation tank than the suction port is disposed.

According to the above arrangement, the powder in the transportation tank can surely be discharged out of the transportation tank through the outlet. In addition, since the outlet is disposed nearer to the end than the suction port is disposed, the powder outside the transportation tank can be prevented from being sucked through the outlet at the time when the gas in the transportation tank is sucked through the suction port. Therefore, the powder in the transporting container can surely be sucked.

Preferably, the wall positioned in an upper part of the transportation tank is provided with a proximity wall which is positioned above the outlet and is close to the conveying device.

According to the above arrangement, there is provided no space for storing the powder at an upper pat of the outlet. In this manner, due to the absence of the space for storing therein the powder at the upper part of the outlet, it is possible to reduce the amount of powder to be stored at the outlet and the fluctuation in the amount of transportation of the powder can be reduced.

It is preferable that the suction port has attached thereto a filter which allows for the suction device to suck the gas in the transportation tank and which prevents the powder in the transportation tank from leaking through the suction port.

According to the above arrangement, since the suction port has attached thereto the filter, the powder can be separated from the suction device. Since the powder is prevented from coming into direct contact with the suction device, it becomes possible to apply grease and the like to the suction device, thereby resulting in a reduced driving power and in a longer lifetime.

It is preferable that the powder transporting apparatus further comprises a piping part having formed therein a flow passage for connecting the powder container and the transportation tank together thereby allowing the powder to flow therethrough. The piping part comprises: small-diameter sections connected to the powder container and the transportation tank, respectively; and a large-diameter section provided between the small-diameter sections and having a cross-sectional area which is larger than those of the small-diameter sections.

According to this arrangement, the transportation tank and the powder container are disposed separately and are connected together by the piping part. In addition, the piping part has the small-diameter section and the large-diameter sections. Therefore, the powder disperses at the time of flowing through the pipe to enter the large-diameter sections from the small-diameter sections. As a result, it becomes possible to loosen the powder which may have got compacted after the lapse of time (i.e., the bulk density of the powder is lowered), and to minimize the reverse flow of the powder without using a mechanical valve. It becomes possible to transport the powder which has a high probability of coagulation.

Preferably, the piping part has a plurality of small-diameter sections.

According to this arrangement, the powder can get loosened at a plurality of stages between the powder container and the transportation tank, resulting in a higher capability of transporting powder having high coagulating characteristics.

In addition, the suction device is preferably constructed to be capable of supplying gas into the transportation tank.

According to this arrangement, it is possible to cause the gas to flow in both the positive-pressure direction and the negative-pressure direction, whereby the filter can be cleaned by reverse flow. Clogging of the filter can thus be prevented, resulting in a longer life of the filter.

The suction device of this apparatus is preferably capable, after having sucked the gas in the transportation tank, of equalizing the pressure in the transportation tank with the pressure outside thereof.

According to this arrangement, after the suction device has sucked the gas from inside the transportation tank, the pressure inside the transportation tank is made equal to the pressure outside the transportation tank. Therefore, after the gas has been sucked into the transportation tank, gas will not enter the transportation tank. Falling of the powder due to the incoming gas can thus be prevented, and consequent fluctuation in the amount of powder to be transported can be reduced.

It is preferable that the powder transporting apparatus further comprises a discharge pipe which is made of an elastic material and is connected to the outlet.

According to this arrangement, since the discharge pipe which is connected to another device on the downstream side of the transportation tank is made of an elastic material, the powder transporting apparatus and another device can be completely hermetically sealed. As a result, there is no possibility of scattering of the powder.

The powder transporting apparatus preferably further comprises an open/close device which is capable of opening and closing the discharge pipe.

According to the above arrangement, since the discharge pipe which is connected to another device on the downstream side of the transportation tank is made of an elastic material, the discharge pipe can be hermetically sealed by crushing the discharge pipe with the open/close device. As a result, the powder transporting apparatus and another device can be completely hermetically sealed, resulting in no scattering of the powder.

The powder transporting apparatus preferably further comprises a control device which causes, in a state in which the open/close device has closed the discharge pipe, the suction device to send gas into the transportation tank.

According to this arrangement, even the powder in the powder container can be loosened. As a result, it becomes possible to supply the powder in a non-coagulated state.

The control device preferably discharges the powder in the transportation tank from the outlet, by causing the suction device to send the gas into the transportation tank in a state in which the open/close device has left the discharge pipe open.

According to the above arrangement, in a state in which the open/close device has left the discharge pipe open, while the filter is being cleaned by applying the positive pressure (back washing), the gas is entrained into the space among the particles which have poor flowability, whereby the flowability of the powder can be improved. As a result, there can be supplied a powder transporting apparatus which is long-lived and has a high performance.

Preferably, the control device discharges the powder in the transportation tank from the outlet, by causing the suction device to send gas into the transportation tank in a state in which the open/close device has left the discharge pipe open.

According to the above arrangement, by applying a positive pressure in a state in which the open/close device keeps the discharge pipe open, the filter can be washed back (cleaned) and, at the same time, the air can be entrained into the space among the particles which are poor in flowability, resulting in an improvement in the flowability of the powder. As a result, there can be supplied a powder transporting apparatus which is long-lived and high in performance.

Preferably, the control device operates to suck the powder in the powder container, by causing the suction device to suck the gas in the transportation tank in a state in which the open/close device has closed the discharge pipe,

According to the above arrangement, since the suction device sucks the gas in the transportation tank in a state in which the open/close device keeps the discharge pipe closed, the powder in the powder container can be sucked surely into the transportation tank.

Preferably, the control device operates such that the time at which the suction device sucks the gas in the transportation tank in a state in which discharge pipe is kept closed is shorter than the time at which the suction device sends the gas into the transportation tank in a state in which the discharge pipe is kept open by the control device.

According to the above arrangement, since the time for the suction device to suck the powder is shorter than the time for the suction device to discharge the powder, the filter can be prevented from getting clogged.

The powder transporting apparatus preferably further comprises a pressure detecting device which is capable of detecting the pressure in the transportation tank.

According to the above arrangement, since the pressure detecting device for detecting the pressure generated by the suction device is provided, the occurrence of the generation of negative pressure due to deterioration after the lapse of time can be detected. Therefore, it becomes possible to take the necessary steps to increase the pressure at the time when pressure decrease occurs due, e.g., to the deterioration after the lapse of time and the like.

In the apparatus, the suction device is preferably arranged to be capable of varying the pressure to be generated in the transportation tank.

According to the above arrangement, by making the pressure of the suction device to be variable, the pressure can be increased at the time of pressure decease due to deterioration after the lapse of time and the like. Therefore, it becomes possible to provide a long-lived powder transporting apparatus.

The suction device is preferably arranged to be capable of varying the time to generate the pressure in the transportation tank.

According to the arrangement, since the time to generate the pressure in the suction device can be varied, it is possible to widely cope with the powder of different flowability and specific gravity, thereby dealing with various kinds of powders.

Preferably, the conveying device is provided with a bar-like shaft, and a vane which extends from the outside surface of the shaft into a spiral shape.

According to this arrangement, by transporting the powder by means of a conveying device having a vane of spiral shape, the toner can be transported by a small amount at a time.

Preferably, toner is fed to the developing apparatus as the powder.

According to this arrangement, by loosening the powder, the toner can be fed by a small amount at a time without giving thermal stress to the low-melting point toner

Preferably, the residual toner as the powder is fed to the recovery container.

According to this arrangement, it becomes possible to transport the powder which is poor in flowability. In this manner, low-melting point toner and the toner that remains after development, and he like can be transported.

Preferably, an image forming apparatus comprises an image carrying body, a development device, and a powder transporting apparatus for supplying toner as powder to the development device, wherein the powder transporting apparatus is the one as described hereinabove.

According to this arrangement, since the above-described powder transporting apparatus is provided, it becomes possible to transport the low-melting point powder without subjecting it to the thermal stress by loosening it. It is thus possible to provide the image forming apparatus which is free from toner scattering, is energy saving and is long lived.

Although the invention has been fully described in connection with the preferred embodiments thereof with reference to the accompanying drawings, it is to be noted that various changes and modifications are apparent to those skilled in the art. Accordingly, the preferred embodiments of the invention as set forth above are intended to be illustrative, not limiting. Various changes to the invention may be made without departing from its true spirit and scope as defined in the following claims.

What is claimed is:

1. A powder transporting apparatus, comprising:
a powder container containing therein powder;
a transportation tank having an inlet for supplying the powder from the powder container, and an outlet for discharging the powder to an outside;
a conveying device disposed in the transportation tank and rotated about an axis to thereby transport the powder in the transportation tank from the inlet to the outlet; and
a suction device disposed outside the transportation tank, the suction device sucking gas in the transportation tank through a suction port which is away from both the inlet and the outlet of the transportation tank, thereby sucking the powder in the powder container into the transportation tank.

2. The apparatus according to claim 1, wherein the inlet is disposed in one of longitudinal ends of the transportation tank and the suction port is disposed in the other of the longitudinal ends thereof, wherein both the inlet and the suction port are disposed in a wall positioned in an upper part of the transportation tank.

3. The apparatus according to claim 2, wherein the wall positioned in an upper part of the transportation tank is provided with a partition wall at a distance from the conveying device, whereby a space is formed between the partition wall and the conveying device.

4. The apparatus according to claim 2, wherein the outlet is disposed in a wall which is positioned in the other of the longitudinal ends of the transportation tank, the wall being also positioned below the conveying device, the outlet being disposed at a position nearer to the other of the longitudinal ends of the transportation tank than the suction port is disposed.

5. The apparatus according to claim 4, wherein the wall positioned in an upper part of the transportation tank is provided with a proximity wall which is positioned above the outlet and is close to the conveying device.

6. The apparatus according to claim 1, wherein the suction port has attached thereto a filter which allows for the suction device to suck the gas in the transportation tank and which prevents the powder in the transportation tank from leaking through the suction port.

7. The apparatus according to claim 1, further comprising a piping part having formed therein a flow passage for connecting the powder container and the transportation tank together thereby allowing the powder to flow therethrough, the piping part comprising: small-diameter sections connected to the powder container and the transportation tank, respectively; and a large-diameter section provided between the small-diameter sections and having a cross-sectional area which is larger than those of the small-diameter sections.

8. The apparatus according to claim 7, wherein the piping part has a plurality of small-diameter parts.

9. The apparatus according to claim 1, wherein the suction device is constructed to be capable of supplying gas into the transportation tank.

10. The apparatus according to claim 9, wherein the suction device is constructed to be capable, after having sucked the gas in the transportation tank, of equalizing the pressure in the transportation tank with the pressure outside thereof.

11. The apparatus according to claim 9, further comprising a discharge pipe which is made of an elastic material and is connected to the outlet.

12. The apparatus according to claim 11, further comprising an open/close device which is capable of opening and closing the discharge pipe.

13. The apparatus according to claim 12, further comprising a control device which causes, in a state in which the open/close device has closed the discharge pipe, the suction device to send gas into the transportation tank.

14. The apparatus according to claim 13, wherein the control device operates to discharge the powder in the transportation tank through the outlet, by causing the suction device to send the gas into the transportation tank in a state in which the open/close device has left the discharge pipe open.

15. The apparatus according to claim 14, wherein the control device operates to suck the powder in the powder container, by causing the suction device to suck the gas in the transportation tank in a state in which the open/close device has closed the discharge pipe.

16. The apparatus according to claim 1, wherein the control device operates such that the time at which the suction device sucks the gas in the transportation tank in a state in which discharge pipe is kept closed is shorter than the time at which the suction device sends the gas into the transportation tank in a state in which the discharge pipe is kept open by the control device.

17. The apparatus according to claim 1, further comprising a pressure detecting device which is capable of detecting the pressure in the transportation tank.

18. The apparatus according to claim 1, wherein the suction device is arranged to be capable of varying the pressure to be generated in the transportation tank.

19. The apparatus according to claim 1, wherein the suction device is arranged to be capable of varying the time to generate the pressure in the transportation tank.

20. An image forming apparatus comprising an image carrying body, a development device, and a powder transporting apparatus for supplying toner as powder to the development device, wherein the powder transporting apparatus is as set forth in claim 1.
